(19) United States
(12) Patent Application Publication
(10) Pub. No.: US 2008/0003144 A1
(43) Pub. Date: Jan. 3, 2008

(54) SAMPLING DEVICE

(76) Inventors: Brendi M. Cumberland, Pleasanton, CA (US); Alan J. Fujii, Newport Beach, CA (US); Scott D. Manske, Pleasanton, CA (US); Elias A. Shaheen, Danville, CA (US)

Correspondence Address: THE CLOROX COMPANY, P.O. BOX 24305, OAKLAND, CA, 94623-1305, US

(21) Appl. No.: 11/427,469

(22) Filed: Jun. 29, 2006

(51) Int. Cl. B01L 3/00

(52) U.S. Cl. 422/99

(57) ABSTRACT

Provided is sampling device and method for the detection of an analyte of interest on an environmental surface. The sampling device includes a first reservoir adapted to contain a first liquid, a second reservoir adapted to contain a second liquid, a swab holder coupled to the first reservoir and the second reservoir, a swab disposed within the swab holder, and an activation member coupled to the first and second reservoirs opposite the swab holder. After the swab is used to collect a sample from an environmental surface, and upon application of an activation force on the activation member, the first and second reservoirs are placed in fluid communication with the swab holder and the first and second liquids flow into the swab holder to contact the swab. The swab develops an indicator color if the sample of the environmental surface contained the analyte of interest.

### BACKGROUND OF THE INVENTION

1. Field of the Invention

The present invention relates generally to disposable calorimetric sampling devices, and, more specifically, to a disposable calorimetric sampling device for the detection of protein-containing substances.

2. Description of the Related Art

With the increased awareness of health and wellness in the home and other indoor environments, there is growing interest in assessing how efficacious household cleaning products are in denaturing/destroying mold, allergens and other proteins known to potentially cause negative health effects.

Colorimetric assays utilizing sampling devices for the detection of protein in biological samples are commonly used across various industries (biotech, healthcare, food, etc). These sampling devices require minimal manipulation of the protein-containing samples and allow for rapid qualitative and quantitative results.

Among the various available calorimetric protein assays is one disclosed in U.S. Pat. No. 4,839,295 to Smith, incorporated herein in its entirety, that utilizes a Bicinchonic Acid (BCA) protein assay. This assay is based on the initial complexation of Copper [II], hereinafter Cu⁺⁺ or cupric ion, with protein peptides under alkaline conditions, with the reduction to Copper [I], hereinafter Cu⁺ or the cuprous ion, in a concentration-dependent manner. The ligand BCA is then added in excess, and a purple color develops (562 nm peak absorbance) upon binding of BCA with Cu⁺.

Protein detection assays are available through biotechnology companies such as Pierce and Sigma, and Biotrace International. In one prior art assay, a plunger, whose reagent-covered swab is used to collect a sample, is inserted into a covered chamber containing reagent and kept separate from the actual plunger.

However, there is a need for the development of a sampling device and method that is equally reliable to the other options already available on the market, but that can also be more conveniently distributed to a larger number of people, more conveniently used in the home, and easily disposed. The current methods of protein detection are unsuitable for home diagnostic applications because of their lack of user-friendly qualities for those not skilled in science, the possibility of misplacing their multiple parts, and the lack of an efficient means of distributing the product to the consumers at a low cost. Further, there is a need for the development of a sampling device with additional versatility to accommodate multiple reagent liquids in one sampling device. Accordingly, there is a need for improved methods and a versatile sampling device for the rapid detection of proteins in mold, allergens or other protein-containing substance for convenient use in a household.

### SUMMARY OF THE INVENTION

The aforementioned needs are satisfied by the sampling device of the present invention that includes a first reservoir adapted to contain a first liquid, a second reservoir adapted to contain a second liquid, and an activation member coupled to both the first reservoir and the second reservoir. A swab holder is coupled to the first and second reservoirs opposite the activation member and is adapted to contain a swab.

The first reservoir is configured as a frangible tube having an open-end portion and a closed-end portion opposite the open-end portion. The second reservoir is similarly configured as a frangible tube having an open-end portion and a closed-end portion opposite the open-end portion. The first and second reservoirs restrict contained liquids against flow through their open-end portions by capillary action.

The activation member is coupled to both the first and second reservoirs at their respective closed-end portions. Weakened portions of the tubes making up the first and second reservoirs are adjacent respective closed-end portions of the first and second reservoirs.

The swab holder defines a cavity and has a swab holder opening or aperture. The swab holder is coupled to the first and second reservoirs at a reservoir-coupling end opposite the swab holder opening of the swab holder. The reservoir-coupling end of the swab holder is open to the first and second reservoirs allowing the swab holder to be placed in fluid communication with the first and second reservoirs.

A swab is disposed within the cavity defined by the swab holder. The swab may project beyond the swab holder opening of the swab holder to allow for easier sampling of an environmental surface by the swab during use of the sampling device. In one embodiment, the swab is configured as a pad of absorbent non-woven material.

Prior to use of the sampling device of the present invention, the swab may be protected from moisture and contaminants in the ambient environment by a swab protector removably coupled to the peripheral edge of the swab holder opening of the swab holder. The swab protector is configured as sheet-like layer overlying the swab and closing off the swab holder opening of the swab holder. The swab protector also protects the first and second liquids since, prior to use of the sampling device of the present invention, the first and second reservoirs are not open to the ambient environment. In one embodiment, the swab protector, once first removed, may be replaced on the swab holder and re-coupled thereto to again protect the swab from contaminants in the ambient environment.

Upon application of an activation force on the activation member, the first reservoir and the second reservoir are placed in fluid communication with the swab holder and the first and second liquids flow into the swab holder and contact the swab. In one embodiment of the present invention, the activation member is configured as rigid tab coupled to the closed-end portions of both the first and second reservoirs. The application of the activation force breaks the weakened portions of the tubes making up the first and second reservoirs adjacent their respective closed-end portions thereby opening up the closed-end portions of the first and second reservoirs to the atmosphere. The capillary forces holding the first and second liquids in their respective reservoirs are released allowing the liquids to flow into the swab holder. In one embodiment, a mixing chamber is interposed between the reservoirs and the swab holder to intermingle the first and second liquids prior to their flowing into the swab holder and contacting the swab.

In another embodiment, each of the first and second reservoirs is separately coupled to a first activation member and a second activation member, respectively. Upon application of a first activation force on the first activation member, the first reservoir is place in fluid communication with the swab holder; and upon application of a second activation force on the second activation member, the second reservoir is placed in fluid communication with the swab holder. By this means, the first liquid and the second liquid may be made to separately flow into the swab holder and contact the swab.

The first and second liquids may be reagents used to performed calorimetric analysis of environmental samples. In one specific calorimetric analysis, the first reagent is BCA and the second reagent is a copper sulfate solution, which together may be used to perform a protein analysis. Alternately, the first liquid may be a wetting agent used to first wet the swab prior to sampling to increase the amount of analyte taken by the swab during environmental sampling. Further, the swab itself may contain absorbed liquids such as a reagent, may be pre-wetted with a wetting agent or may contain a solid reagent or other material adhered to or adsorbed within the swab. Other liquids or solid materials suitable for use with the sampling device of the present invention for calorimetric analysis or other uses would be readily apparent to one of ordinary skill in the art.

A method for use of a sampling device for the rapid calorimetric detection of proteins in mold, allergens or other protein-containing substances is provided. The method comprises selecting materials of construction for the sampling device that are compatible with the respective liquids contained in the first and second reservoirs. Next, the first and second reservoirs are loaded with their respective liquids. The swab is next fixed in placed in the swab holder and the removable swab protector is placed at the peripheral edge of the swab holder opening of the swab holder. The sampling device may be stored until needed.

When needed to perform an analysis, the swab protector is removed and the swab is swiped over the surface of a sampling object. The first and second reservoirs are next placed in fluid communication with the swab holder by application of an activation force on the activation member.

A sufficient duration of time is allowed to pass for the development of a positive test result indicator color. If a color develops, the presence of a protein-containing substance on the surface of the test object is confirmed. If no indicator color develops, the absence any protein-containing substance on the surface of the test object is confirmed.

Further features and advantages of the present invention will become apparent to those of ordinary skill in the art in view of the detailed description of exemplary embodiments below, when considered together with the attached drawings and claims.

### BRIEF DESCRIPTION OF THE DRAWINGS

Reference will now be made to the drawings wherein like numerals refer to like parts throughout, and wherein:

FIG. 1 is an isometric view of a sampling device according to the principles of the present invention that shows a first and second reservoir, a swab holder, and an activation member;

FIG. 2 is an isometric view of the sampling device of FIG. 1 in an inverted position that shows a swab protector coupled to the swab holder;

FIG. 3 is an exploded view of the sampling device of FIG. 2 that shows the swab holder, the swab, and the a swab protector;

FIG. 4 is a longitudinal cross-sectional view of the sampling device of FIG. 1;

FIG. 5 is a close-up view of the closed-end portion of the first and second reservoirs of FIG. 1 that shows the activation member coupled to the reservoirs before activation of the sampling device;

FIG. 6 is a close-up view of the swab holder of FIG. 2 that shows removal of the swab protector during use of the sampling device;

FIG. 7 is a close-up view of the closed-end portion of the first and second reservoirs of FIG. 1 that shows the activation member coupled to the reservoirs after activation of the sampling device;

FIG. 8A is a an isometric view of the sampling device of FIG. 1 in an inverted position that shows a positive result for the detection of protein-containing substances after use in sampling;

FIG. 8B is a an isometric view of the sampling device of FIG. 1 in an inverted position that shows a negative result for the detection of protein-containing substances after use in sampling; and

FIG. 9 is a process flow diagram for a method for the use of the sampling device of FIG. 1 in the rapid calorimetric detection of proteins in mold, allergens or other protein-containing substances.

### DETAILED DESCRIPTION

The embodiments disclosed herein are described in the context of a sampling device for the rapid detection of proteins in mold, allergens or other protein-containing substances. One of ordinary skill in the art would recognize, however, that the materials and methods disclosed herein will have application in a number of other contexts where sampling and detection of the presence or absence of a particular compound is desirable, particularly where simplicity and ease of use of a sampling/detection device is important.

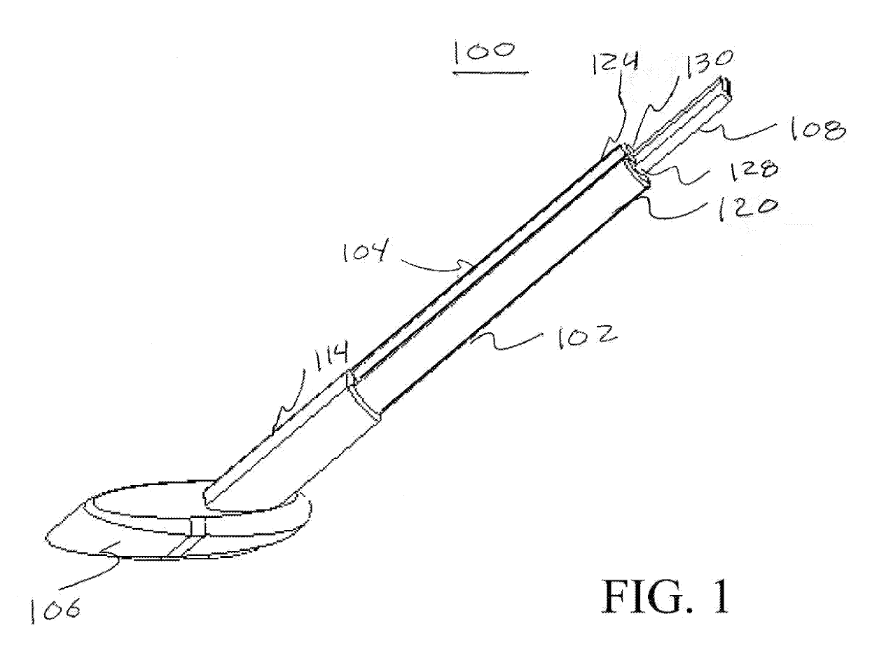

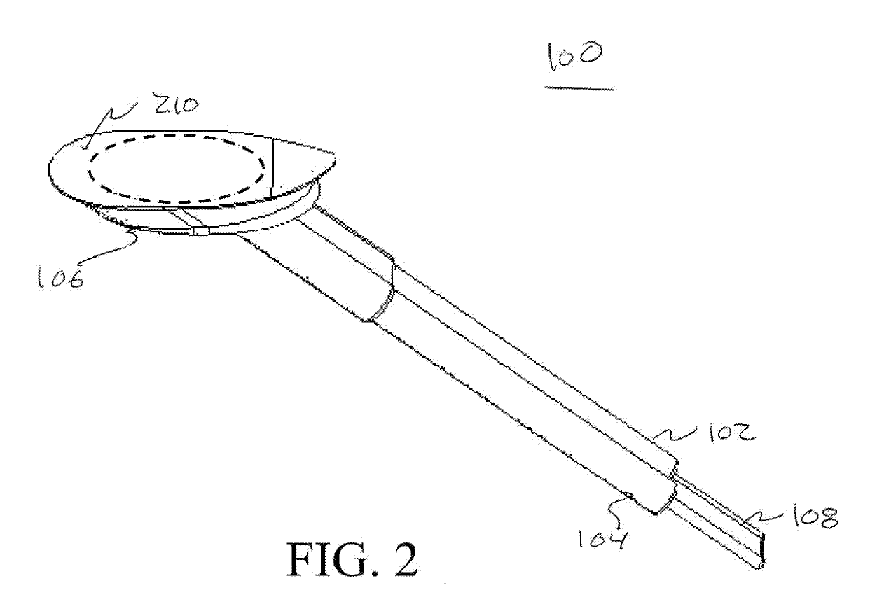

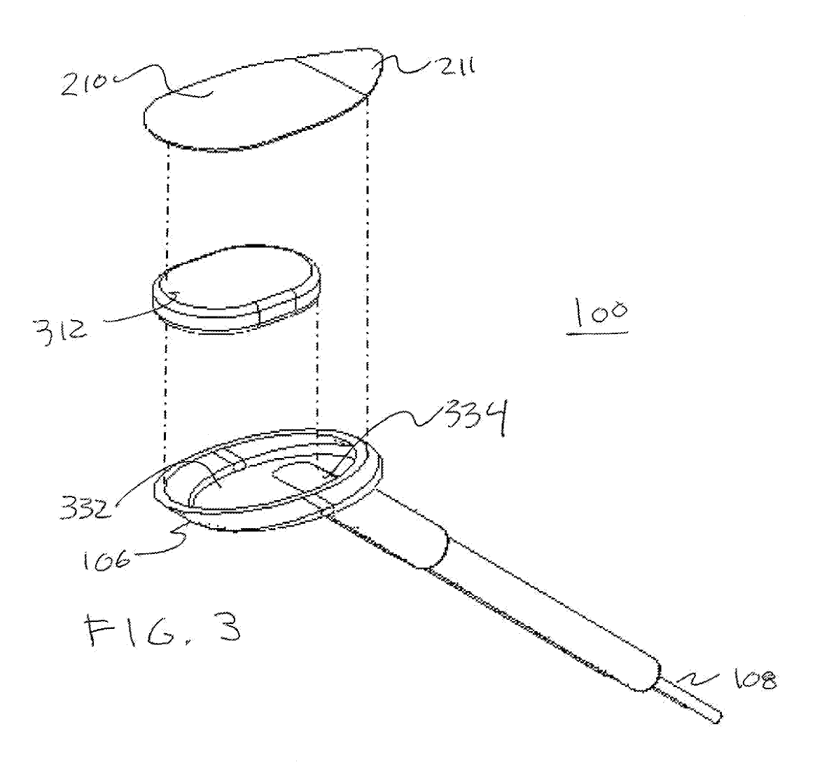

FIG. 1 is an isometric view of a sampling device 100 according to the principles of the present invention that shows a first reservoir 102 and second reservoir 104, a swab holder 106, and an activation member 108. FIG. 2 is an isometric view of sampling device 100 in an inverted position that shows a swab protector 210 coupled to swab holder 106. As used herein, positional terms, such as “inverted”, “top” and “bottom” and the like, and directional terms, such as “up”, “down”, and the like, are employed for ease of description in conjunction with the drawings. These terms are not meant to indicate that the components of the present invention must have a specific orientation except when specifically set forth below. FIG. 3 is an exploded view of sampling device 100 of that shows swab holder 106, a swab 312 disposed within swab holder 106, and swab protector 210.

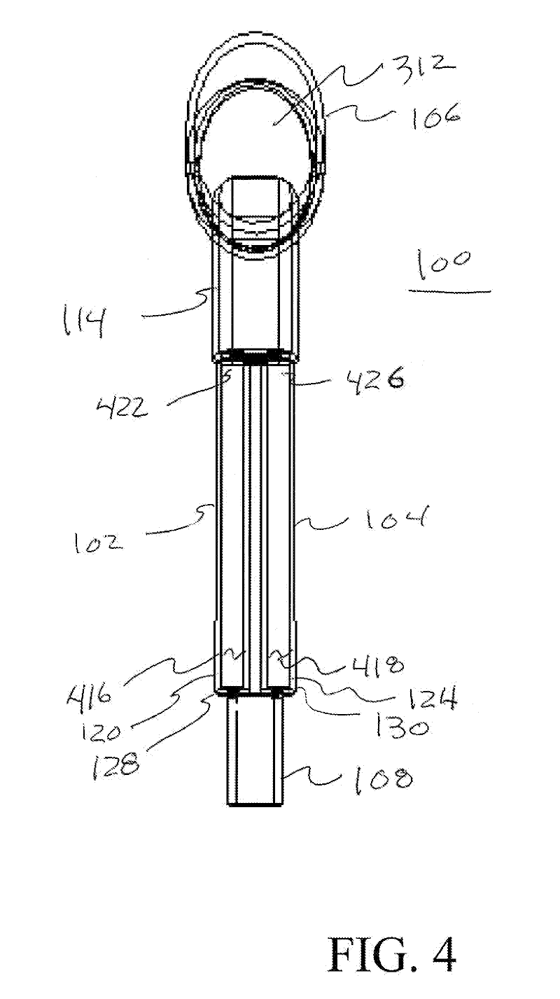

Referring to FIGS. 1, 2, and 3 together, sampling device 100 of the present invention includes first reservoir 102 adapted to contain a first liquid 416 (FIG. 4), second reservoir 104 adapted to contain a second liquid 418, and activation member 108 coupled to both first reagent reservoir 102 and second reagent reservoir 104. Swab holder 106 is coupled to first and second reservoirs 102 and 104 opposite activation member 108 and is adapted to contain swab 312. In one embodiment, a mixing chamber 114 IS placed between both of first and second reservoirs 102 and 104 and swab holder 106. First liquid 416 may include a wetting agent, a reagent, a biological growth medium, or other flowable liquid.

More particularly, first reservoir 102 and second reservoir 104 are each configured as slender frangible tube adapted to contain a first liquid 416 (FIG. 4) and a second liquid 418 (FIG. 4), respectively. First reservoir has a closed-end portion 120 and an open-end portion 422 (FIG. 4) opposite closed-end portion 120. Second reservoir 104 is similarly configured as a frangible tube having a closed-end portion 124 and an open-end portion 426 (FIG. 4) opposite closed-end portion 124. The first and second reservoirs 102 and 104 restrict their respective liquids 416 and 418 against flow through their respective open-end portions 422 and 426 by capillary action.

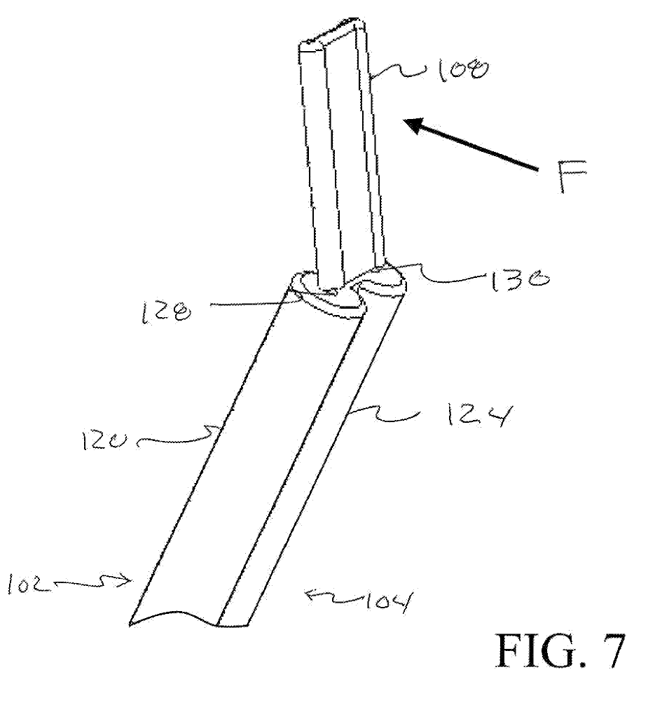

As described more fully below, first reservoir 102 includes a weaken portion 128 proximate closed-end portion 120 of first reservoir 102. Similarly, second reservoir 104 includes a weaken portion 130 proximate closed-end portion 124 of second reservoir 104. Weakened portions 128 and 130 are adapted to break upon application of an application force F (FIG. 7) on activation member 108.

Activation member 108 is coupled to both first reservoir 102 and second reservoir 104 at their respective closed-end portions 120 and 124. In another embodiment, activation member 106 is bifurcated into portions, (not separately shown). An activation member first portion is coupled only to first reservoir 102 at its closed-end portion 120 and an activation member second portion is coupled only to second reservoir 104 at its closed-end portion 424. Upon application of a first activation force on the first activation member, first reservoir 102 is place in fluid communication with swab holder 106; and upon application of a second activation force on the second activation member, second reservoir 104 is placed in fluid communication with swab holder 106. By this means, first liquid 416 and second liquid 418 may be made to separately flow into swab holder 106 and contact swab 312.

Swab holder 106 defines a cavity and has a swab holder opening 332 (FIG. 3) at one end of swab holder 106. Swab holder 106 is coupled to first reservoir 102 and second reservoir 104 at a reservoir-coupling end 334 opposite the swab holder opening 332 of swab holder 106. As also described more fully below, reservoir-coupling end 334 of swab holder 106 is open to first reservoir 102 and second reservoir 104 allowing swab holder 106 to be concurrently placed in fluid communication with first and second reservoir 104 and 106 respectively. In the embodiment noted above wherein activation member 108 is bifurcated, each of first reservoir 102 and second reservoir 104 may be placed in fluid communication with swab holder 106 independently.

Swab 312 is disposed within the cavity defined by swab holder 106. Swab 312 may project beyond swab holder opening 332 of the swab holder 106 to allow swab 312 to easily sample an environmental surface during use of sampling device 100. In one embodiment, swab 312 is configured as a pad of absorbent non-woven material adapted to retain, for example, reagent liquids or adsorbed solid particulate or crystalline compounds. In one example, swab 312 contains a color developer, such as copper sulfate (CuSO4) solution, that has been dried on swab 312 to deposit CuSO4 salt on the non-woven material of swab 312. Swab 312 may be fixed within swab holder 106 with, for example, adhesives or fasteners. First reservoir 102 contains a wetting agent and second reservoir 104 contains a protein sensitive reagent, such as BCA. In this example, CuSO4 salt impregnated swab 312 may be used with the wetting agent of first reservoir 102 and the BCA of second reservoir 104 to perform a protein assay.

Overlying swab 312 is swab protector 210. Swab protector is a flexible sheet-like layer that closes off swab holder opening 332 of swab holder 106, thereby isolating swab holder 106, and swab 312 contained therein, from moister, dust and other contaminants in the ambient environment. In one embodiment, swab protector is opaque to light to protect against deterioration of swab 312 or any material on swab 312 from exposure to light. The bottom peripheral edges of swab protector 210 may contain an adhesive material (not shown) to removably couple and provide a seal between the peripheral edge of swab holder opening 332 of swab holder 106 to protect swab 312 from the ambient environment. Other means to couple swab protector 210 to swab holder 106 are possible, such as, by way of example and not by way of limitation, static cling, “hook” and “loop”, and thermo set adhesive such as found on inductive seals well known to those of ordinary skill in the art. In one embodiment, swab protector 210 may be replaceable to again close off swab holder opening 332 after having been removed.

Prior to use of the sampling device 100, swab protector 210 also protects first liquid 416 disposed within the interior space defined by first reservoir 102 and second liquid 418 disposed within the interior space defined by second reservoir 104. Respective closed-end potions 120 and 124 of first and second reservoirs 102 and 104, together with swab protector 210, isolate reservoirs 102 and 104 from the ambient environment.

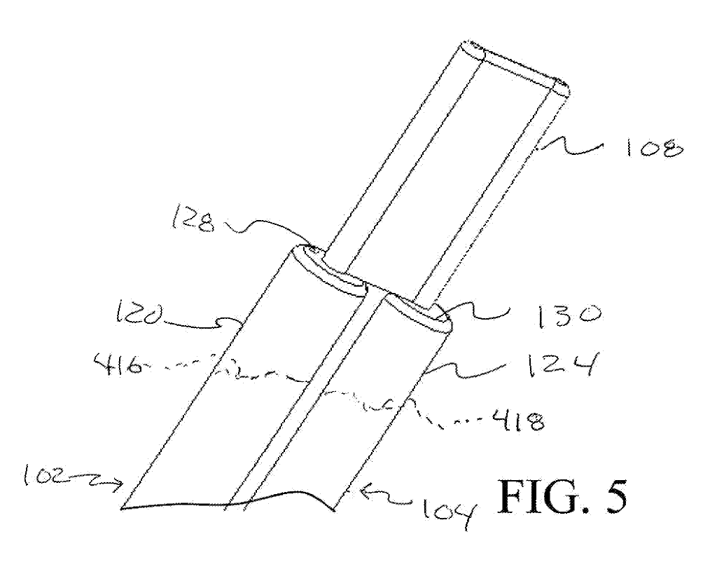

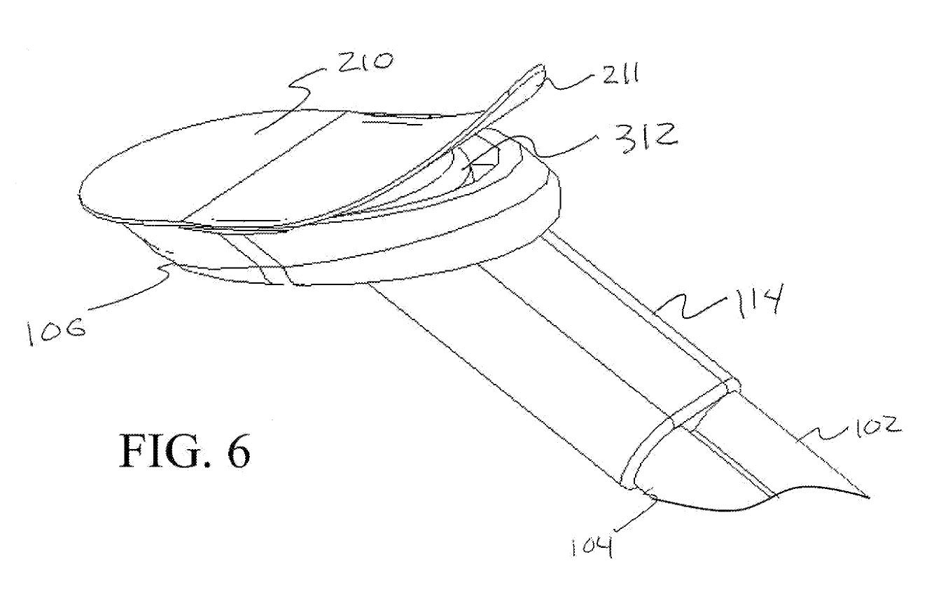

FIG. 5 is a close-up view of the closed-end portions 120 and 124 of the first and second reservoirs 102 and 104, respectively, that shows activation member 108 coupled to the reservoirs before activation of sampling device 100. FIG. 6 is a close-up view of swab holder 106 that shows removal of swab protector 210 during use of sampling device 100. FIG. 7 is a close-up view of closed-end portions 120 and 124 of first and second reservoirs 102 and 104 that shows activation member 108 coupled to the reservoirs after activation of sampling device 100.

Referring to FIGS. 5, 6, and 7 together, prior to use of sampling device 100, activation member 108 is coupled to closed-end portions 120 and 124 of first reservoir and second reservoir 102 and 104, respectively. Weaken portion 128 of first reservoir 102 and weaken portion 130 of second reservoir 104 are intact. Thus, respective closed-end portions 120 and 124 act to contain first liquid 416 in first reservoir 102 act second liquid 418 in second reservoir 104 by capillary action. Further, prior to use swab protector 210 maintains a seal between swab holder 106 and the ambient environment.

During use of sampling device 100, sampling device 100 is inverted and swab protector tab 211 (FIG. 6) of swab protector 210 is grasped by a user of sampling device 100 and swab protector 210 is pealed back to expose swab 312. Next, sampling device 100 is positioned so that exposed swab 312 is may be used to swab an environmental surface to obtain a sample of one or more analytes of interest that may be present on the environmental surface. The user samples the environmental surface by swiping the now exposed swab 312 across the environmental surface to adhere to swab 312 a portion of any analyte of interest that the surface may contain. A user may apply force with a forefinger placed on the top surface of swab holder 106 during sampling to assure good contact between swab 312 and the environmental surface being sampled.

Next, after a sample has been obtained, the user of sampling device 100 applies a lateral activation force F on activation member 108 (FIG. 7). Upon application of activation force F on activation member 108, weakened portions 128 and 130 of respective first and second reservoirs 102 and 104 are severed from their respective closed-end portions 120 and 124 to opening up closed-end portions 120 and 124 to atmosphere. The capillary forces holding first and second liquids 416 and 418 in their respective reservoirs are released. First reservoir 102 and second reservoir 104 are placed in fluid communication with swab holder 106 allowing respective first and second liquids 416 and 418 to flow into swab holder 106 to contact swab 312. In one embodiment, mixing chamber 114 interposed between both the first and second reservoirs 102 and 104 intermingles first and second liquids 416 and 418 prior to their flowing into swab holder 106 and contacting the swab 312.

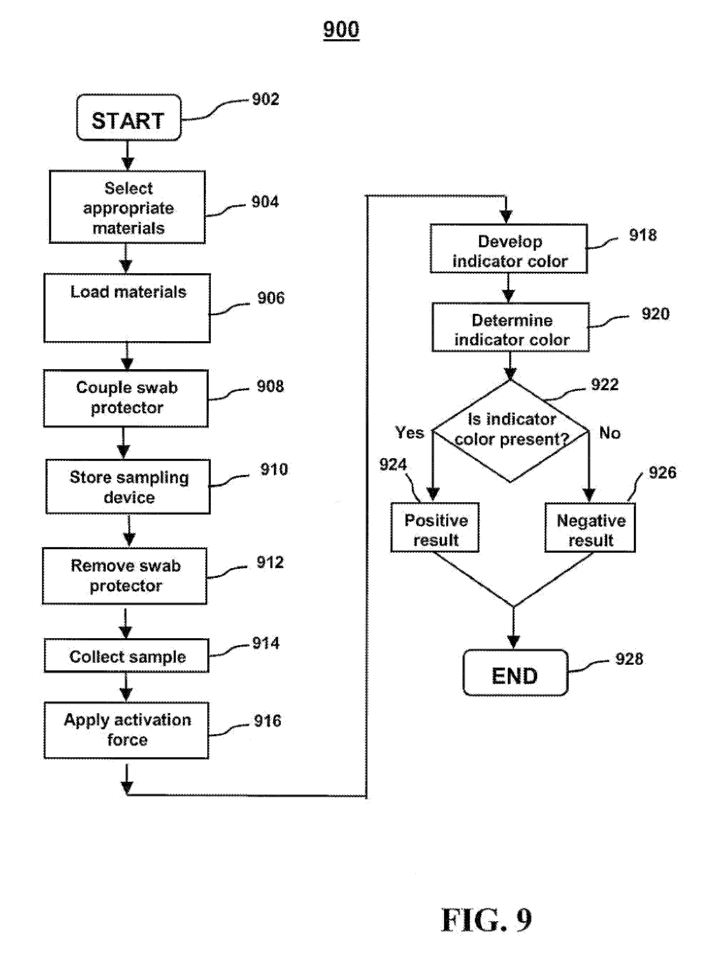

FIG. 9 is a process flow diagram for a method 900 of use of sampling device 100 in the rapid calorimetric detection of proteins in mold, allergens or other protein-containing substances. In one embodiment, method 900 utilizes the reagents disclosed by Smith. Referring to FIGS. 1,3,4, and 9 together, start operation 902 of method 900 commences the use of sampling device 100 for the calorimetric detection of proteins. Start operation 902 transfers to select appropriate materials operation 904. In operation 904, the materials of construction of the sampling device including first reservoir 102, second reservoir 104, swab holder 106, swab 312, and swab protector 210 are all selected to be compatible with the first and second liquids 416 and 418. In one embodiment the material of construction are selected to be compatible with reagent system disclosed by Smith. After appropriate materials are selected, operation 904 of method 900 transfers to load reservoir operation 906.

In load materials operation 906, first and second reservoirs 102 and 104 are loaded with first liquid 416 and second liquid 418, respectively. First liquid 416 is BCA and second liquid 418 is a Cu⁺⁺ containing solution such as a copper sulfate solution. First and second liquids 416 and 418 are loaded by pouring liquid BCA into the open-end portions 422 and 426 of first and second reservoirs 102 and 104, respectively, after sampling device 100 has been placed an inverted position such that open-end portions 422 and 426 pointed upwardly. After first and second liquids 416 and 418 are loaded, swab 312 is coupled to swab holder 106. Swab 106 may be coupled to swab holder by various means that are compatible with contact with BCA and Cu⁺⁺ containing solutions. After swab 312 is coupled to swab holder 106, the operation 906 transfers to couple swab protector operation 908.

In couple swab protector operation 908, swab protector 210, configured as a flexible sheet-like layer, is placed over swab holder opening 332 of swab holder 106 and to the peripheral edge of swab holder opening 332. Swab protector 210 may contain an adhesive material (not shown) on its peripheral edge to removably couple and provide a seal between swab holder 106 and the ambient environment to provide isolation of swab 312, first liquid 416, and second liquid 418 from moister, dust and other contaminants in the ambient environment that may interfere with the successful operation of method 900. Further, swab protector 210 precludes fluid communication between first and second liquids 416 and 418 contained in first reservoir 102 and second reservoir 104 before commencement of develop indicator color operation 918 described below. After completion of couple swab protector operation 908, store sampling device operation 910 may commence with sampling device 100. In store sampling device operation 910, sampling device 100 may be stored until needed to carry out the detection of proteins in mold, allergens or other protein-containing substances.

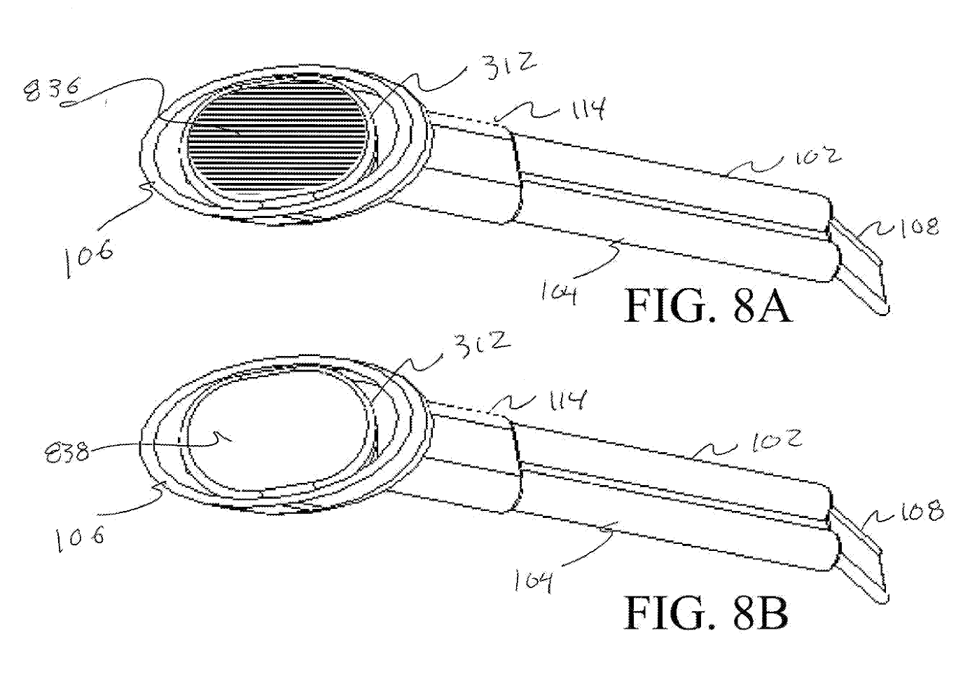

FIG. 8A is an isometric view of sampling device 100 in an inverted position that shows a positive result for the detection of protein-containing substances. FIG. 8B is an isometric view of sampling device 100 in an inverted position that shows a negative result for the detection of protein-containing substances. Referring now to FIGS. 8A, 8B, and 9, when sampling device 100 is used to carry out the detection of proteins on an environmental surface, operation 910 transfers to remove swab protector operation 912. In operation 912, swab protector 210 (FIG. 2) is removed from swab holder 106 to expose swab 312 disposed therein. A user peels off first swab protector 210 by grasping swab protector tab 211 and pulling off swab protector 211 from its attachment to swab holder 106. After swab protector 210 is removed from swab holder 106, operation 912 transfers to collect sample operation 914.

In operation 914, a user of sampling device 100 wipes an environmental surface for which protein determination is desired with now exposed swab 312. Swab 312 of sampling device 100 collects a sample of mold, allergen, etc., which include protein-containing peptides, from the environmental surface and retains the sample on the absorbent non-woven substrate material of swab 312. After the protein sample is secured on swab 312, operation 914 transfers to apply activation force operation 916.

In operation 916, while sampling device 100 is placed upright with the closed-end portions 120 and 124 of respective first and second reservoirs 102 and 104 above respective open-end portions 422 and 426, a user of sampling device 100 applies an activation force F (FIG. 7) to break off closed-end portions of 120 and 124 of respective reservoirs 102 and 104 at their respective weakened portions 128 and 130. When the closed-end portions 120 and 124 are broken off, first and second reservoirs 102 and 104 are subjected to atmospheric pressure. The BCA in first reservoir 102 and the Cu⁺⁺ containing solution in second reservoir 104 flows through the open-end portions 422 and 426 respectively and comes into fluid communication with swab holder 106 through reservoir coupling end 334 of swab holder 106. Mixing chamber 114 mixes the BCA and the Cu⁺⁺ containing solution before they contact swab holder 106 to avoid channeling of these liquids. After the BCA and the Cu⁺⁺ containing solution contact swab holder 106, and thus swab 312 disposed therein, operation 916 transfers to develop indicator color operation 918.

In operation 918, a user of sampling device 100 allows sufficient time for full development of the color on swab 106 that indicates the presence of protein containing substances. An intense purple color develops upon binding of BCA with Cu⁺ that forms from the reduction of Cu⁺⁺ in contact with any protein containing substances, as indicated by the horizontal hatching on swab 312 in FIG. 8A. The purple color of a swab positive result 836 develops when protein-containing substances, such as mold and allergens, are collected from the candidate environmental surface onto swab 312 during collect sample operation 914 described above. In operation 918, a purple color on swab 106 does not develop, as indicated by the lack of hatching on swab 106 in FIG. 8B in a swab negative result 838, when protein-containing substances are not present on the candidate environmental surface. Those of ordinary skill in the art will understand that the sensitivity of sampling device 100 and the duration required for full development of swab positive result 836 may be controlled by the strength and nature of the reagents used with sampling device 100. After sufficient time has passed for full development of the indicator color, operation 918 transfers to determine indicator color 920.

In determine indicator color 920, a user of sampling device 100 observes the presence or absence of the above described purple indicator color on swab 106. After a user has determined the presence or absence of the purple color, operation 920 transfers to “is color present?” operation 922.

In operation 922, a user answers the question affirmatively “YES” by observing is the color of swab 106 with the purple indicator color present, i.e., swab positive result 836; or negatively “NO” for the purple indicator color not present.

If the result of operation 922 is “YES” for the indicator color, operation 922 transfers to positive result operation 924 where the presence of protein-containing substances on the sampled environmental surface is confirmed resulting in the end of method 900 at end operation 928. If the result of operation 922 is “NO” for lack of the indicator color, operation 922 transfers to negative result operation 926 where the absence of protein-containing substances on the sampled environmental surface is confirmed resulting in the end of method 900 at end operation 928.

The present invention has been described herein in considerable detail to provide those skilled in the art with information relevant to apply the novel principles and to construct and use such specialized components as are required. Specifically, embodiments of the sampling device and method have been described with reference to the detection of protein-containing substance such as mold and allergens. More specifically, the present invention has been described with reference to a specific calorimetric test. However, the present invention is adaptable to any number of calorimetric tests. Further, it is to be understood that the present invention can be carried out by different equipment, materials and devices, and that various modifications, both as to the equipment and operating procedures, can be accomplished without departing from the scope of the invention itself. For example, the sampling device of the present invention may include at least one additional liquid reservoir coupled to the swab holder and adapted to contain an additional liquid.

We claim:

1. A sampling device comprising:
a first reservoir adapted to contain a first liquid;
a second reservoir adapted to contain a second liquid;
a swab holder coupled to said first reservoir and said second reservoir;
a swab disposed within said swab holder;
an activation member coupled to said first reagent reservoir and said second reagent reservoir opposite said swab holder; and
wherein, upon application of an activation force on said activation member, said first reservoir and said second reservoir are placed in fluid communication with said swab holder and said first liquid and said second liquid flow into said swab holder.

2. The sampling device of claim 1 wherein said first liquid comprises BCA.

3. The sampling device of claim 1 wherein said second liquid comprises a Cu⁺⁺ containing solution.

4. The sampling device of claim 1 wherein said swab comprises absorbent non-woven material.

5. The sampling device of claim 1 wherein said swab projects beyond a swab opening of said swab holder.

6. The sampling device of claim 1 further comprising a swab protector removably coupled to said swab holder.

7. The sampling device of claim 6 wherein said swab protector is configured as a flexible, sheet-like layer.

8. The sampling device of claim 6 wherein said swab protector once first removed from said swab holder may be re-coupled to said swab holder.

9. The sampling device of claim 6 wherein said swab protector is opaque.

10. The sampling device of claim 1 wherein said activation member is configured as a rigid tab.

11. The sampling device of claim 1:
wherein said first reservoir contains a Cu⁺⁺ containing solution; and
wherein said second reservoir contains BCA.

12. The sampling device of claim 1:
wherein said first reservoir comprises:
a frangible tube having an open-end portion and a closed-end portion opposite said open-end portion;
wherein said second reservoir comprises:
a frangible tube having an open-end portion and a closed-end portion opposite said open-end portion; and
wherein said first reservoir and said second reservoirs restrict respective liquids contained therein against flow through said open-end portion of said first reservoir and said open-end portion of said second reservoir, respectively, by capillary action.

13. The sampling device of claim 12:
wherein said first reservoir further comprises a weakened portion proximate said closed-end portion of said first reservoir, and;
wherein said second reservoir further comprises a weakened portion proximate said closed-end portion of said second reservoir.

14. The sampling device of claim 1 wherein said activation member is bifurcated into a first activation member coupled to said first reservoir and a second activation member coupled to said second reservoir.

15. The sampling device of claim 14:
wherein, upon application of a first activation force on said first activation member, said first liquid flows to said swab holder, and;
wherein, upon application of a second activation force on said second activation member, said second fluid flows to said swab holder.

16. The sampling device of claim 1 further comprising at least one additional reservoir coupled to said swab holder and adapted to contain an additional liquid.

17. A method for the use of a sampling device of claim 1 for the rapid calorimetric detection of proteins in mold, allergens, or other protein-containing substances comprising:
selecting materials of construction of said sampling device that are compatible with a first liquid and a second liquid in disposed in said sampling device;
loading said first liquid and said second liquid into said sampling device;
coupling a swab protector of said sampling device to a swab holder of said sampling device;
storing said sampling device until use;
removing said swab protector from said swab holder;
collecting a sample from a candidate environmental surface with a swab disposed in said swab holder;
applying an activation force on an activation member of said sampling device to flow said first liquid and said second liquid into said swab holder;
developing an indicator color on said swab; and
determining the presence or absence of said indicator color.

18. The method of claim 16 wherein said first liquid comprises BCA and said second liquid comprises a Cu⁺⁺ containing solution.
